(19) United States
(12) Patent Application Publication
(10) Pub. No.: US 2010/0128108 A1
(43) Pub. Date: May 27, 2010

(54) APPARATUS AND METHOD FOR ACQUIRING WIDE DYNAMIC RANGE IMAGE IN AN IMAGE PROCESSING APPARATUS

(75) Inventors: Kwan-Woong SONG, Seongnam-si (KR); Young-Hun JOO, Yongin-si (KR); Yong-Serk KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/626,133

(22) Filed: Nov. 25, 2009

(30) Foreign Application Priority Data
Nov. 27, 2008 (KR) 10-2008-0118603

(51) Int. Cl. H04N 13/02

(52) U.S. Cl. 348/46; 348/E13.074

(57) ABSTRACT

A method is provided for acquiring a Wide Dynamic Range (WDR) image in an image processing apparatus, in which images corresponding to each of consecutive frames are photographed with a stereo camera including at least two image pickup devices with different exposure times, a correlation between images photographed in each frame at different exposure times is checked, and the images photographed at the different exposure times are synthesized into one image based on the correlation.

### CROSS-REFERENCE TO RELATED PATENT APPLICATION

This application claims the benefit under 35 U.S.C. §119(a) of a Korean Patent Application No. 10-2008-0118603 filed in the Korean Intellectual Property Office on Nov. 27, 2008, the entire disclosure of which is hereby incorporated by reference.

### BACKGROUND OF THE INVENTION

1. Field of the Invention

Exemplary embodiments relate to an image processing apparatus, and more particularly, to an apparatus and method for acquiring a Wide Dynamic Range (WDR) image in an image processing apparatus.

2. Description of the Related Art

To meet the increasing user demands for digital image processing apparatuses, including digital cameras, digital camcorders and camera phones, their functions have been diversified and sophisticated.

However, an image processing apparatus lacks an ability to process all information about a real scene because its acquirable dynamic range is very small compared to a dynamic range of the real scene. In particular, when the image processing apparatus acquires an image in a degraded state such as in a backlight state, it is not possible to acquire sufficient information about the brightest portions and the darkest portions in the image, causing significant degradation of image quality in the related regions.

To address these problems, image processing apparatuses use a Wide Dynamic Range (WDR) technique.

The WDR technique, a method for improving quality of an image using two or more images, improves the image quality by widening a dynamic range based on images that are acquired with different exposure times.

FIG. 1 shows an example of acquiring an image using a WDR technique in a conventional image processing apparatus.

Referring to FIG. 1, the conventional image processing apparatus acquires a WDR image 150 using a bright image 110 acquired at a long exposure time and a dark image 130 acquired at a short exposure time.

As described above, the conventional image processing apparatus may acquire a WDR image using images of a stationary subject.

However, when an image processing apparatus attempts to acquire a WDR image using images of a moving subject, the image processing apparatus should acquire two images but it is not easy to acquire the same images because of user's handshaking, thus causing significant motion blurring due to features of video images (or sequences).

Accordingly, there is a need for a new scheme for efficiently acquiring a WDR image using images in an image processing apparatus.

### SUMMARY OF THE INVENTION

Exemplary embodiments may address at least the above-mentioned problems and/or disadvantages and to provide at least the advantages described below. Accordingly, an aspect of the present disclosure provides a method and apparatus for acquiring a WDR image in an image processing apparatus.

Another aspect provides a method and apparatus for acquiring a WDR image based on a stereo camera in an image processing apparatus.

According to one aspect of the present disclosure, there is provided an apparatus for acquiring a Wide Dynamic Range (WDR) image in an image processing apparatus, in which a stereo camera includes at least two image pickup devices that photograph images corresponding to each of one or more frames with different exposure times, an image acquirer provides different exposure times to the at least two image pickup devices constituting the stereo camera, acquires images photographed in each frame by the at least two image pickup devices, and outputs the acquired images on a frame basis, and a WDR processor checks a correlation between the images photographed in each frame with different exposure times, and synthesizes the images photographed with different exposure times into one image based on the correlation.

According to another aspect, there is provided a method for acquiring a WDR image in an image processing apparatus, in which images corresponding to each of one or more frames are photographed with a stereo camera including at least two image pickup devices with different exposure times, a correlation between images photographed in each frame with different exposure times is checked, and the images photographed at the different exposure times are synthesized into one image based on the correlation.

### BRIEF DESCRIPTION OF THE DRAWINGS

The above and other aspects and advantages of certain exemplary embodiments will be more apparent from the following description taken in conjunction with the accompanying drawings, in which:

FIG. 1 is a diagram showing an example of acquiring an image using a WDR technique in a related art image processing apparatus;

FIG. 2 is a schematic block diagram of an image processing apparatus according to an exemplary embodiment;

FIG. 3 is a diagram showing an example of controlling exposure times of first and second lenses according to an exemplary embodiment;

FIG. 4 is a diagram showing a WDR technique for acquiring WDR images according to an exemplary embodiment;

FIG. 5 is a flowchart showing a method for processing images according to an exemplary embodiment; and

FIG. 6 is a diagram showing an example of a portable terminal with a built-in stereo camera according to an exemplary embodiment.

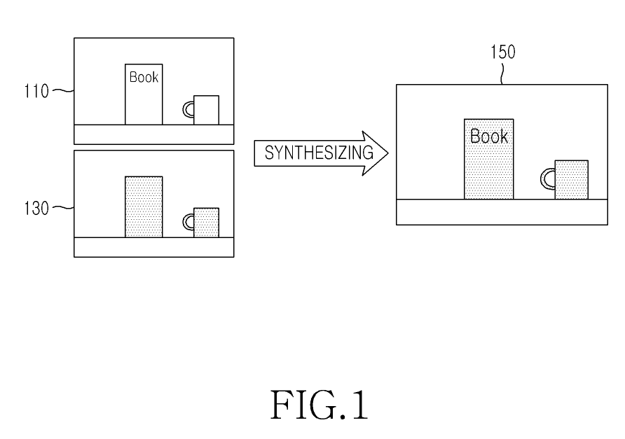

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

Exemplary embodiments are directed to acquiring a WDR image by synthesizing images (a bright or light image L acquired for a long exposure time and a dark or somber image S acquired for a short exposure time) acquired for different exposure times on a frame basis by means of a stereo camera in an image processing apparatus.

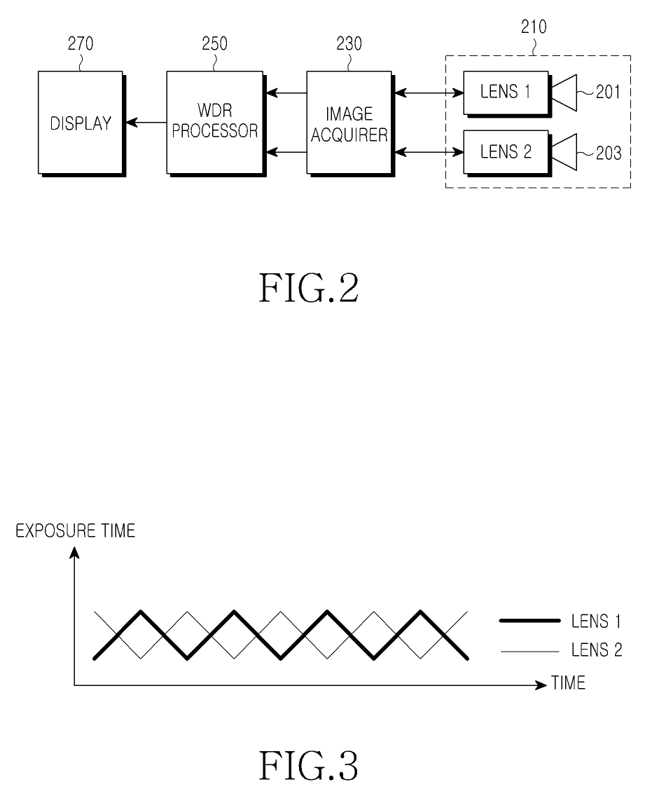

FIG. 2 schematically shows an image processing apparatus according to an exemplary embodiment.

Referring to FIG. 2, the image processing apparatus includes a stereo camera 210, an image acquirer 230, a WDR processor 250, and a display 270.

The stereo camera 210 includes a pair of image pickup devices, for example a first lens 201 and a second lens 203, and photographs (or captures) images with the first lens 201 and the second lens 203 on a frame basis. The first lens 201 and the second lens 203 are image pickup devices that can photograph both of a video image (or video sequence) of a moving subject and a still image of a stationary subject. Thus, the images photographed by the first lens 201 and the second lens 203 are video images or still images.

The stereo camera 210 photographs images S and L with different exposure times on a frame basis using the first lens 201 and the second lens 203, and outputs them to the image acquirer 230. The exposure times are controlled by control signals from the image acquirer 230.

For example, if the first lens 201 photographs an image for a long exposure time, the second lens 203 photographs an image for a short exposure time. On the contrary, if the first lens 203 photographs an image for a short exposure time, the second lens photographs an image for a long exposure time. That is, the exposure times of the first lens 201 and the second lens 203 are different.

If the first lens 201 has photographed an image corresponding to the current frame for a short exposure time, it will photograph an image for a long exposure time in the next frame. Similarly, if the second lens 203 has photographed an image corresponding to the current frame for a long exposure time, it will photograph an image for a short exposure time in the next frame.

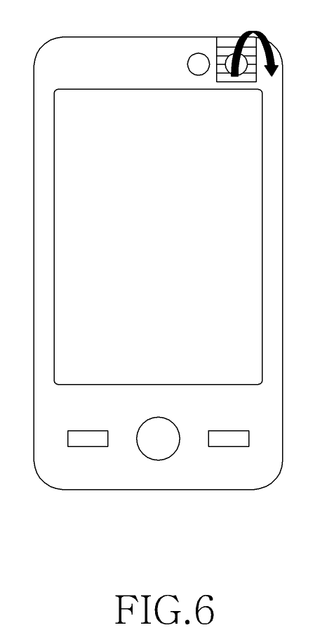

The stereo camera 210 may be embodied in a portable terminal as shown in FIG. 6.

FIG. 6 shows an example of a portable terminal with a stereo camera embodied therein according to an embodiment.

A 3^{rd} Generation (3G) terminal may include both of a camera for image/video photographing and a camera for video communication. As shown in FIG. 6, at least one camera may be designed in a terminal to be rotatable by 180° by a rotation mechanism. In this case, if two cameras face the same direction, they may function as a stereo camera.

The image acquirer 230 provides control signals to the stereo camera 210 so that images in the same frames may have different exposure times as shown in FIG. 3.

The image acquirer 230 outputs control signals so as to alternately provide different exposure times to two lenses constituting the stereo camera 210 in every frame.

For example, in order to photograph images corresponding to an arbitrary frame, control signals for allowing the first lens 201 to have a long exposure time and the second lens 203 to have a short exposure time are provided to the stereo camera 210. In order to photograph images corresponding to the next frame, control signals for allowing the first lens 201 to have a short exposure time and the second lens 203 to have a long exposure time are provided to the stereo camera 210.

FIG. 3 shows an example of controlling exposure times of first and second lenses according to an embodiment.

Control signals shown in FIG. 3 are signals for controlling exposure times of images in each frame in a zigzag manner so that images in the same frame, which are photographed by the first lens 201 and the second lens 203 of the stereo camera 210, have different exposure times.

In FIG. 3, the zigzag exposure times are subject to change according to a moving speed of a subject and an operation speed of the camera (or operation speed of the lenses). For example, the long exposure time and the short exposure time may change in inverse proportion to the moving speed of the subject and the operation speed of the camera. Preferably, as the moving speed of the subject and the operation speed of the camera increase, the long exposure time and the short exposure time decrease. In contrast, as the moving speed of the subject and the operation speed of the camera decrease, the long exposure time and the short exposure time increase.

Accordingly, if the image acquirer 230 controls exposure times of images in a zigzag fashion as stated above, it can acquire images that the stereo camera 210 photographed in the same frame with different exposure times. Because the exposure times of the images photographed in the same frame are different from each other, it is not necessary to rearrange images having the different exposure times in each frame.

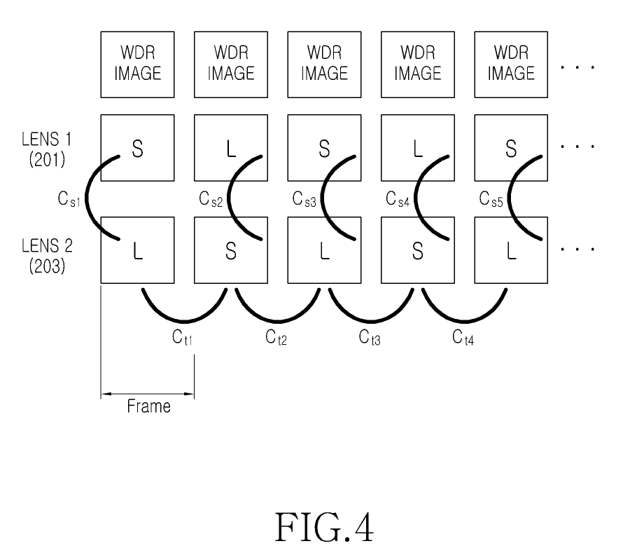

The WDR processor 250 acquires a WDR image based on a WDR technique as shown in FIG. 4, using the images photographed in the same frame with different exposure times. The acquired WDR image is provided to a user on the display 270.

A method of acquiring a WDR image in the WDR processor 250 will be described with reference to FIG. 4.

FIG. 4 shows a WDR technique for acquiring WDR images according to an embodiment.

Referring to FIG. 4, the WDR processor 250 acquires a WDR image by synthesizing images S and L that are acquired in each frame for different exposure times.

The WDR technique used in the WDR processor 250 will be described in detail. The WDR processor 250 checks a correlation between the images S and L acquired for different exposure times, and selects a matching point in each image based on the checked correlation.

Because correlations (Cₛ₁, Cₛ₂, Cₛ₃, Cₛ₄, Cₛ₅) between different images in the same frames are greater than correlations (Cₜ₁, Cₜ₂, Cₜ₃, Cₜ₄) between different images in different frames (i.e., time), the WDR processor 250 checks correlations (Cₛ₁, Cₛ₂, Cₛ₃, Cₛ₄, Cₛ₅) between the images acquired in the same frames for different exposure times.

Since the correlations (Cₛ₁, Cₛ₂, Cₛ₃, Cₛ₄, Cₛ₅) between the images acquired in the same frames for the different exposure times are very high, the WDR processor 250 may check Cₛ₂ taking Cₛ₁ into account. That is, the WDR processor 250 may check Cₛ for the remaining frames except for the first frame taking into account the previous Cₛ, thereby reducing the entire computation.

In addition, the WDR processor 250 generates a camera response function for the matching point selected in each image so as to minimize the energy predefined according to the current state, and then acquires a WDR image by mapping exposure times and pixel values to WDR pixel values based on the generated camera response function.

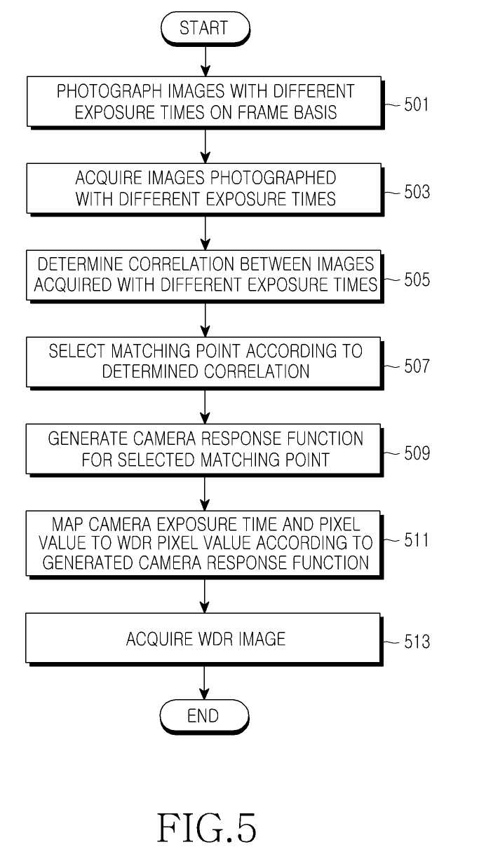

FIG. 5 shows a method for processing images according to an embodiment.

Referring to FIG. 5, in step 501, the stereo camera 210 photographs images with different exposure times on a frame basis by means of the first lens 201 and the second lens 203 according to control signals received from the image acquirer 230. In step 503, the image acquirer 230 acquires the images photographed with different exposure times.

In step 505, the WDR processor 250 checks a correlation between images photographed in the same frame with different exposure times. In step 507, the WDR processor 250 selects a matching point in each image considering the checked correlation. In step 509, the WDR processor 250 generates a camera response function for the matching point selected in each image so as to minimize the energy predefined according to the current state. In step 511, the WDR processor 250 maps exposure times and pixel values to WDR pixel values according to the generated camera response function. In step 513, the WDR processor 250 acquires a WDR image. The acquired WDR image is provided to the user on the display 270.

As is apparent from the foregoing description, according to exemplary embodiments, the same image is photographed at the same time using a stereo camera. Therefore, it is possible to prevent motion blurring from occurring due to a long exposure time between two adjacent frames, thus preventing occurrence of mismatch between images.

In addition, according to exemplary embodiments, WDR images may be acquired using the stereo camera without generating virtual exposure frames, and a correlation between images can be checked depending on a correlation of the previous frame, thereby reducing computation. The computation reduction reduces the buffering and processing time, facilitating real-time acquisition of WDR images.

Furthermore, the use of a correlation between images in the same frame enables easy and accurate selection of a matching point.

Besides, according to exemplary embodiments, WDR images may be acquired of a moving subject, so it is possible to acquire WDR images despite the occurrence of a scene change.

Also, exemplary embodiments may be easily realized with a stereo camera.

While the invention has been shown and described with reference to certain exemplary embodiments thereof, it will be understood by those skilled in the art that various changes in form and details may be made therein without departing from the spirit and scope of the invention as defined by the appended claims and their equivalents.

For example, while it is described that the stereo camera includes two image pickup devices in the foregoing description, embodiments may be equally applied even to a stereo camera consisting of two or more image pickup devices. However, if the number of image pickup devices constituting the stereo camera increases, the exposure time may be subdivided according to the number of image pickup devices.

What is claimed is:

1. An apparatus for acquiring a Wide Dynamic Range (WDR) image in an image processing apparatus, comprising:
a stereo camera comprising at least two image pickup devices that photograph images of each of one or more frames with different exposure times;
an image acquirer which controls the exposure times of the at least two image pickup devices, acquires the images photographed by the at least two image pickup devices, and outputs the acquired images of each of the one or more frames; and
a WDR processor which determines a correlation between the images photographed of each of the one or more frames with different exposure times, and synthesizes the images photographed with different exposure times into one image based on the correlation.

2. The apparatus of claim 1, wherein the image acquirer controls the exposure times of the at least two image pickup devices, such that the exposure time of each image pickup device changes with each frame.

3. The apparatus of claim 1, wherein, for each frame, the image acquirer controls the exposure times of the at least two image pickup devices, such that for each frame, one of the at least two image pickup devices is provided with a first exposure time and another of the at least two image pickup devices is provided with a second exposure time, shorter than the first exposure time.

4. The apparatus of claim 3, wherein the image acquirer determines the first exposure time and the second exposure time based on a moving speed of a subject to be photographed and an operation speed of the image pickup devices.

5. The apparatus of claim 1, wherein the WDR processor:
checks a correlation between images photographed in each frame with different exposure times;
selects a matching point between the images photographed with the different exposure times based on the correlation;
generates a camera response function for the selected matching point; and
synthesizes the images acquired with the different exposure times by mapping the exposure times and pixel values for the images to WDR pixel values according to the generated camera response function.

6. The apparatus of claim 3, wherein one of the at least two image pickup devices is an image pickup device for video photographing, and one of the at least two image pickup devices is an image pickup device for video communication.

7. The apparatus of claim 6, further comprising a rotation mechanism which rotates one of the image pickup device for video photographing and the image pickup device for video communication.

8. The apparatus of claim 1, wherein the images photographed are video images or still images.

9. A method for acquiring a Wide Dynamic Range (WDR) image in an image processing apparatus, comprising:
photographing images corresponding to each of one or more frames, with a stereo camera comprising at least two image pickup devices, with different exposure times;
checking a correlation between images photographed of each of the one or more frames with different exposure times; and
synthesizing the images photographed with the different exposure times into one image based on the correlation.

10. The method of claim 9, further comprising changing, with each frame, an exposure time with which each of the at least two image pickup devices photographs.

11. The method of claim 9, wherein, for each frame, a first exposure time is applied to one of the at least two image pickup devices and a second exposure time, shorter than the first exposure time, is applied to another of at least two image pickup devices.

12. The method of claim 11, further comprising determining the first exposure time and the second exposure time based on a moving speed of a subject to be photographed and an operation speed of the image pickup devices.

13. The method of claim 9, wherein the synthesizing comprises:
selecting a matching point between images photographed with different exposure times based on the correlation;
generating a camera response function for the selected matching point; and
synthesizing the images photographed with the different exposure times by mapping the exposure times and pixel values for the images to WDR pixel values according to the generated camera response function.

14. The method of claim 11, wherein one of the at least two image pickup devices is an image pickup device for video photographing and one of the at least two image pickup devices is an image pickup device for video communication.

15. The method of claim 14, wherein one of the image pickup devices for video photographing and the image pickup device for video communication is rotatable by a rotation mechanism.

16. The method of claim 9, wherein the images photographed are video images or still images.
